(19) United States
(12) Patent Application Publication
(10) Pub. No.: US 2005/0097605 A1
(43) Pub. Date: May 5, 2005

(54) Broadcast receiver, broadcast receiving method, program recording apparatus, and program recording method

(75) Inventor: Shingo Itou, Sayama-shi (JP)

Correspondence Address: PILLSBURY WINTHROP, LLP, P.O. BOX 10500, MCLEAN, VA, 22102, US

(73) Assignee: Kabushiki Kaisha Toshiba, Tokyo (JP)

(21) Appl. No.: 10/946,363

(22) Filed: Sep. 22, 2004

(30) Foreign Application Priority Data
Nov. 5, 2003 (JP) 2003-376013

(51) Int. Cl. H04N 5/445; G06F 3/00; G06F 13/00

(52) U.S. Cl. 725/45; 725/46; 725/39

(57) ABSTRACT

If a broadcast receiver has a record of having obtained program guide information from a server before, information about the date and time of the last acquisition of program guide information is presented to the server. When requested to obtain program guide information in a state where there is a record of having obtained program guide information from the server before, the server outputs program guide information containing changes or additions made to the last program guide information during a period between the date and time of the last acquisition of program guide information and the present time. The broadcast receiver receives the program guide information from the server, retains information about the date and time of the acquisition of the program guide information, and updates the electronic program guide on the basis of the program guide information obtained.

### CROSS-REFERENCE TO RELATED APPLICATIONS

This application is based upon and claims the benefit of priority from prior Japanese Patent Application No. 2003-376013, filed Nov. 5, 2003, the entire contents of which are incorporated herein by reference.

### BACKGROUND OF THE INVENTION

1. Field of the Invention

The present invention relates to a broadcast receiver having a function of reserving programs scheduled to be broadcast utilizing program guide information obtained over an information network, a broadcast receiving method, a program recording apparatus, and a program recording method.

2. Description of the Related Art

As is well known, the digitization of television broadcasting has been pushed forward in recent years. In Japan, not only satellite digital broadcasting, such as BS (Broadcasting Satellite) digital broadcasting and 110-degree CS (Communication Satellite) digital broadcasting, but also terrestrial digital broadcasting has been started.

A television broadcast receiver adapted for such digital television broadcasting has a program reserve function built in, which involves previously reserving a program scheduled to be broadcast, automatically receiving that program when it is broadcast, and digital-recording it on a recording medium, such as a DVD (Digital Versatile Disk) or HDD (Hard Disk Drive).

For the program reserve function, in general, the television broadcast receiver receives EPG (Electronic Program Guide) information which is program guide information periodically published through digital broadcasting and then creates an electronic program guide on the basis of that EPG information.

The user selects a desired program from broadcasting scheduled programs appearing on the electronic program guide. In response to this, the television receiver creates program reserve information including the date of broadcasting of that program, the broadcasting start time, the broadcasting termination time, and the broadcasting channel and enters it into a program reserve list.

A system is now being developed which enables the television broadcast receiver to obtain EPG information at any time from a dedicated server over an information network such as the Internet. This system provides greater convenience in program reservation.

At present, however, such a system is still in the process of development. In particular, the efficiency in obtaining EPG information from the server is not up to a sufficiently practical level.

Japanese Unexamined Patent Publication No. 2003-87751 discloses an arrangement to transmit from a server over a communication line to a terminal computer not only data for displaying an electronic program guide but also attribute data for displaying a program providing method. However, this publication describes nothing about increasing the EPG information obtaining efficiency.

### BRIEF SUMMARY OF THE INVENTION

According to one aspect of the present invention, there is provided a broadcast receiver comprising: a broadcast receiving unit configured to receive a broadcast signal; a program guide information acquisition requesting unit configured to make a request to obtain program guide information for broadcast programs which can be received by the broadcast receiving unit to a server over a communication line and, if there is a record of having obtained program guide information from the server before, to present information about the date and-time of the last acquisition of program guide information to the server; a first program guide information acquisition unit configured to obtain program guide information from the server requested by the program guide information acquisition requesting unit in a state where there is no record of having obtained program guide information from the server before and create an electronic program guide on the basis of the program guide information; and a second program guide information acquisition unit configured to obtain program guide information from the server requested by the program guide information acquisition requesting unit in a state where there is a record of having obtained program guide information from the server before, the program guide information containing changes or additions made to the last program guide information during a period between the date and time of the last acquisition of program guide information and the present time, retain information about the date and time of the acquisition of the program guide information containing changes or additions, and update the electronic program guide on the basis of the program guide information obtained.

According to one aspect of the present invention, there is provided a broadcast receiving method comprising: the step of receiving a broadcast signal; the step of making a decision of, in making a request to obtain program guide information for broadcast programs which can be received to a server over a communication line, whether or not there is a record of having obtained program guide information from the server before; the step of, if there is no record of having obtained program guide information before, making a request to obtain program guide information to the server with notification to the effect that there is no record of having obtained program guide information; the step of obtaining program guide information for all the broadcast programs that can be received from the server requested in a state where there is no record of having obtained program guide information from the server before and then creating an electronic program guide on the basis of the program guide information; the step of, if there is a record of having obtained program guide information before, making a request to obtain program guide information to the server with information indicating the date and time of the last acquisition of program guide information; and the step of obtaining program guide information from the server requested in a state where there is a record of having obtained program guide information from the server before, the program guide information containing changes or additions made to the last program guide information during a period of time between the date and time of the last acquisition of program guide information and the present time, retaining information about the date and time of the acquisition of the program guide information containing changes or additions, and updating the electronic program guide on the basis of the program guide information obtained.

According to one aspect of the present invention, there is provided a program recording apparatus comprising: a broadcast receiving unit configured to receive a broadcast signal; a program guide information acquisition requesting unit configured to make a request to obtain program guide information for broadcast programs which can be received by the broadcast receiving unit to a server over a communication line and, if there is a record of having obtained program guide information from the server before, to present information about the date and time of the last acquisition of program guide information to the server; a first program guide information acquisition unit configured to obtain program guide information from the server requested by the program guide information acquisition requesting unit in a state where there is no record of having obtained program guide information from the server before and create an electronic program guide on the basis of the program guide information; a second program guide information acquisition unit configured to obtain program guide information from the server requested by the program guide information acquisition requesting unit in a state where there is a record of having obtained program guide information from the server before, the program guide information containing changes or additions made to the last program guide information during a period between the date and time of the last acquisition of program guide information and the present time, retain information about the date and time of the acquisition of the program guide information containing changes or additions, and update the electronic program guide on the basis of the program guide information obtained; and a recording unit configured to, in a state where a program has been reserved on the basis of the program guide created or updated by the first or second program guide information acquisition unit, receive the reserved program by the broadcast receiving unit when it is broadcast and recording it on the recording medium.

According to one aspect of the present invention, there is provided a program recording method comprising: the step of receiving a broadcast signal; the step of making a decision of, in making a request to obtain program guide information for broadcast programs which can be received to a server over a communication line, whether or not there is a record of having obtained program guide information from the server before; the step of, if there is no record of having obtained program guide information before, making a request to obtain program guide information to the server with notification to the effect that there is no record of having obtained program guide information; the step of obtaining program guide information for all the broadcast programs that can be received from the server requested in a state where there is no record of having obtained program guide information from the server before and then creating an electronic program guide on the basis of the program guide information; the step of, if there is a record of having obtained program guide information before, making a request to obtain program guide information to the server with information indicating the date and time of the last acquisition of program guide information; the step of obtaining program guide information from the server requested in a state where there is a record of having obtained program guide information from the server before, the program guide information containing changes or additions made to the last program guide information during a period of time between the date and time of the last acquisition of program guide information and the present time, retaining information about the date and time of the acquisition of the program guide information containing changes or additions, and updating the electronic program guide on the basis of the program guide information obtained; the step of reserving a given program for recording on the basis of the program guide; and the step of receiving the reserved program when it is broadcast and recording it on a recording medium.

### BRIEF DESCRIPTION OF THE SEVERAL VIEWS OF THE DRAWING

FIG. 1 is a schematic representation of a network system according to an embodiment of the present invention;

FIG. 2 is a diagram for use in explanation of the main operation of the recording/reproducing apparatus to obtain EPG information from the server;

FIG. 3 is a block diagram of the recording/reproducing apparatus shown in FIG. 1;

FIG. 4 is a flowchart illustrating the operation of the recording/reproducing apparatus to obtain EPG information from the server;

FIG. 5 shows exemplary electronic program guides created on the basis of EPG information obtained from the server;

FIG. 6 shows an example of an electronic program guide updated on the basis of EPG information including additions or changes; and

FIG. 7 is a diagram for use in explanation of a modification of the operation of the recording/reproducing apparatus to obtain EPG information from the server.

### DETAILED DESCRIPTION OF THE INVENTION

An embodiment of the present invention will be described hereinafter with reference to the accompanying drawings. FIG. 1 is a schematic representation of a network system described in this embodiment. In FIG. 1, reference numeral 11 denotes a recording/reproducing apparatus, which has a function of receiving television broadcast signals, a function of reserving programs scheduled to be broadcast, and a function of recording received programs.

The recording/reproducing apparatus 11 is connected through a communication line 12 that conforms to the Ethernet standards to a server 13 for data communication purposes. The server 13 is equipped with a database 14 which stores EPG information. The database 14 is stored with up-to-date EPG information for all the broadcasting stations.

The recording/reproducing apparatus 11 is capable of making a request to the server 13 for EPG information at any time. In this case, the recording/reproducing apparatus 11 outputs a request to obtain EPG information onto the communication line 12. Then, the request for EPG information is sent to the server 13.

Based on the request for EPG information, the server 13 fetches EPG information from the database 14 and outputs it onto the communication line 12. The recording/reproducing apparatus 11 obtains the EPG information sent over the communication line 12. Thus, the recording/reproducing apparatus 11 is allowed to obtain EPG information at any time.

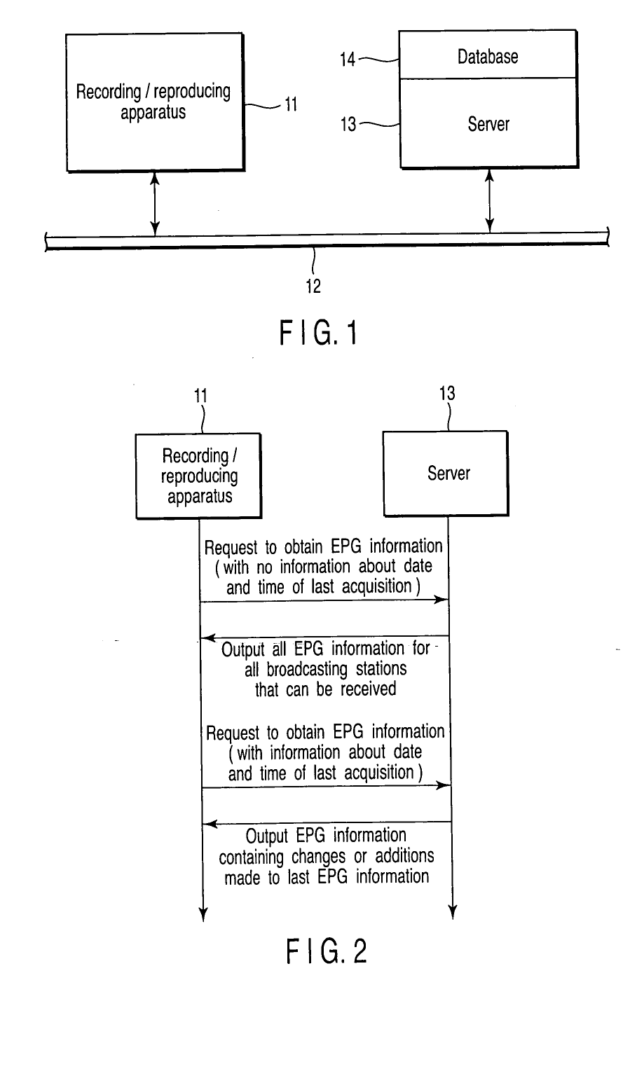

FIG. 2 illustrates main operations involved when the recording/reproducing apparatus 11 obtains EPG information from the server 13. That is, the recording/reproducing apparatus 11 makes a request for EPG information to the server 13 at a certain time. At this point, the recording/reproducing apparatus 11 simultaneously sends to the server 13 information about the date and time when EPG information was obtained last time.

However, in a case where there is no record that the user has obtained EPG information before as when the user purchases the recording/reproducing apparatus 11 and then makes a request for EPG information for the first time, the recording/reproducing apparatus 11 makes a request for EPG information to the server 13 without adding information about the date and time of the last acquisition of EPG information.

Upon receipt of the request for EPG information with no such information added, the server 13 fetches all the EPG information for all the broadcasting stations the service areas of which will cover the area where the recording/reproducing apparatus 11 is installed and sends it to the recording/reproducing apparatus.

Thus, the recording/reproducing apparatus 11 can obtain EPG information from the server 13 to create an electronic program guide from the EPG information. At this point, the recording/reproducing apparatus 11 retains information about the date and time when the EPG information was obtained.

Upon receipt of a request for EPG information with information about the date and time of the last acquisition of EPG information added, on the other hand, the server 13 makes a decision of whether or not at present there are changes or additions to the EPG information sent to the recording/reproducing apparatus 11 last time. If there are changes or additions, then EPG information including the changes or additions is sent to the recording/reproducing apparatus 11, which can update the electronic program guide accordingly.

As described above, in making a request for EPG information to the server 13, the recording/reproducing apparatus 11 presents to the server 13 information about the date and time of the last acquisition of EPG information; therefore, the server 13 simply sends EPG information including changes or additions to the EPG information output last time, allowing the efficiency in acquisition of EPG information to be increased. For this reason, the load on the server 13 can be alleviated and the speed at which EPG information is obtained can be increased.

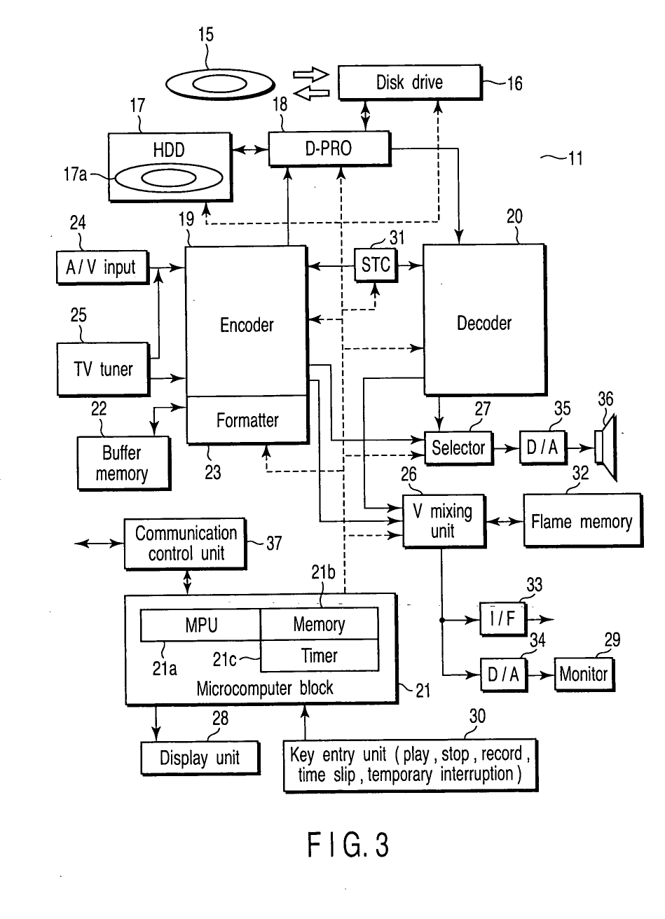

FIG. 3 shows a detailed arrangement of the recording/reproducing apparatus 11. This apparatus uses an optical disk, such as a digital versatile disk (DVD), and a hard disk as recording media; however, for example, a semiconductor memory may be used as a recording medium.

The recording/reproducing apparatus shown in FIG. 3 is roughly divided into main blocks for recording in the left-hand portion of FIG. 3, main blocks for reproduction in the right-hand portion, and main blocks for control in the lower portion.

The recording/reproducing apparatus 11 has two types of disk drives: a disk drive 16 which spins an optical disk 15 as a first media that is an information recording medium capable of creating video files and reads or writes information from or on the optical disk and a hard disk drive (HDD) 17 which drives a hard disk 17a as a second media.

A D-PRO (Data-Processor) unit 18 supplies recording data to the disk drive 16 and the HDD 17 and receives reproduced signals therefrom. The disk drive 16 has a rotation control system, a laser drive system, and an optical system for the optical disk 15. The D-PRO unit 18 manipulates data in recording or reproduction units and includes a buffer circuit, a modulation/demodulation circuit, and an error correction circuit.

The recording/reproducing apparatus 11 is composed mainly of an encoder 19 on the recording side, a decoder 20 on the reproduction side, and a microcomputer block 21 which controls the operation of the recording/reproducing apparatus 11.

The encoder 19 includes video and audio analog-to-digital converters each of which converts a corresponding one of input analog video and audio signals into digital form, a video encoder, an audio encoder, and a sub-picture encoder.

An output signal of the encoder 19 is converted into a predetermined DVD video format by a formatter 23 including a buffer memory 22 and then applied to the D-PRO unit 18.

The encoder 19 is supplied with external analog video and audio signals from an A/V (Audio Video) input unit 24 or analog video and audio signals from a TV (Television) tuner 25.

When directly supplied with compressed digital video and audio signals, the encoder 19 can directly supply them to the formatter 23.

In addition, the encoder 19 can directly supply analog-to-digital converted video and audio signals to a V (Video) mixing unit 26 and an audio selector 27, respectively.

In the video encoder included in the encoder 19, a digital video signal is converted into a digital video signal compressed at variable bit rates based on the MPEG (Moving Pictures Expert Group) 2 or MPEG 1 standard. A digital audio signal is converted into a digital audio signal compressed at a constant bit rate or linear pulse code modulated (PCM) digital audio signal in accordance with the MPEG or AC (Audio Compression)-3 standard.

When a sub-picture signal is input from the A/V input unit 24 (for example, a signal from a DVD video player equipped with an independent output terminal for a sub-picture signal), or when a DVD video signal of such data structure is broadcast and the corresponding channel is selected in the TV tuner 25, the sub-picture signal in the DVD video signal is encoded in the sub-picture encoder (run-length coding) into a sub-picture bit map.

The encoded digital video signal, digital audio signal and sub-picture data are packed in the formatter 23 to form video, audio and sub-picture packs. These packs are collected and converted into a format specified by the DVD video standards (standards for recording on DVD-RAM (Random Access Memory), DVD-RW (Rewritable), and DVD-R (Recordable).

The recording/reproducing apparatus shown in FIG. 3 can supply information formatted by the formatter 23 (video, audio and sub-picture packs) and created management information to the HDD 17 or disk drive 16 through the D-PRO unit 18 and record them on the hard disk 17a or optical disk 15.

Information recorded on the hard disk 17a or the optical disk 15 can also be recorded on the optical disk 15 or the hard disk 17a through the D-PRO unit 18 and the disk drive 16.

The microcomputer block 21 includes an MPU (Micro Processing Unit) 21a, a memory 21b, and a timer 21c. The memory 21b includes a ROM (Read Only Memory) stored with various control programs which are executed by the MPU 21a.

The memory 21b further includes a RAM which provides a work area required for program execution by the MPU 21a and a nonvolatile RAM which holds obtained EPG information, an electronic program guide created based on the EPG information, and information about the date and time when the EPG information was obtained. The timer 21c is used for the program reserve function and to obtain information about the date and time when a request for EPG information was made.

Of the results of execution by the microcomputer 21, the contents the user should be notified are displayed on a display unit 28 built into the recording/reproducing apparatus 11 or OSD (On Screen Display) displayed on an external monitor display 29. The microcomputer 21 has a key entry unit 30 for producing operating signals for operating the recording/reproducing apparatus 11.

The times for the microcomputer block 21 to control the disk drive 16, the HDD 17, the D-PRO unit 18, the encoder 19, the decoder 20, etc. can be determined on the basis of time data from an STC (System Time Clock) 31. The recording or reproducing operation is normally carried out in synchronization with time clocks from the STC 31. The other processes may be performed at times independent of time clocks from the STC 31.

The decoder 20 has a separator which separates each pack from the signal packed in DVD video format, a memory used for pack separation and other signal processing, a V decoder which decodes main video data separated by the separator (the contents of video packs), an SP (Sub Picture) decoder which decodes sub-picture data separated by the separator (the contents of sub-picture packs), and an A (Audio) decoder which decodes audio data separated by the separator (the contents of audio packs). The decoder is further provided with a video processor which combines the decoded sub-pictures with the decoded main video and outputs the main video having a menu, a highlight button, credit titles, subtitles or other sub-pictures superimposed on it.

An output video signal of the decoder 20 is input to the V mixing unit 26 in which text data is synthesized. To the V mixing unit 26 is also connected a line adapted to directly take in a signal from the TV tuner 25 or the A/V input unit 24.

To the V mixing unit 26 is connected a frame memory 32 used as a buffer. When the output of the V mixing unit 26 is an analog signal, it is output to outside through an I/F (Interface) 33. In the case of a digital signal, on the other hand, it is output to an external monitor display 29 through a digital-to-analog (D/A) converter 34.

An output audio signal of the decoder 20 is applied to a digital-to-analog converter 35 via the selector 27 and converted into an analog signal, which is in turn output to an external speaker 36. The selector 27 is controlled by a select signal from the microcomputer block 21. Thereby, the selector 27 is allowed to, when a digital signal from the A/V input unit 24 or the TV tuner 25 is directly monitored, directly select a signal passed through the encoder 19.

The microcomputer block 21 is connected by a communication control unit 37 which conforms to the Ethernet standards to the server 13 through the communication line 12 for data communication purposes. Thereby, the microcomputer block 21 is allowed to make a request to obtain EPG information to the server 13 and obtain all the EPG information or changed EPG information from the server 13. At this point, when EPG information was obtained last time, information about the date and time of the last acquisition of EPG information is sent to the server together with the request for EPG information.

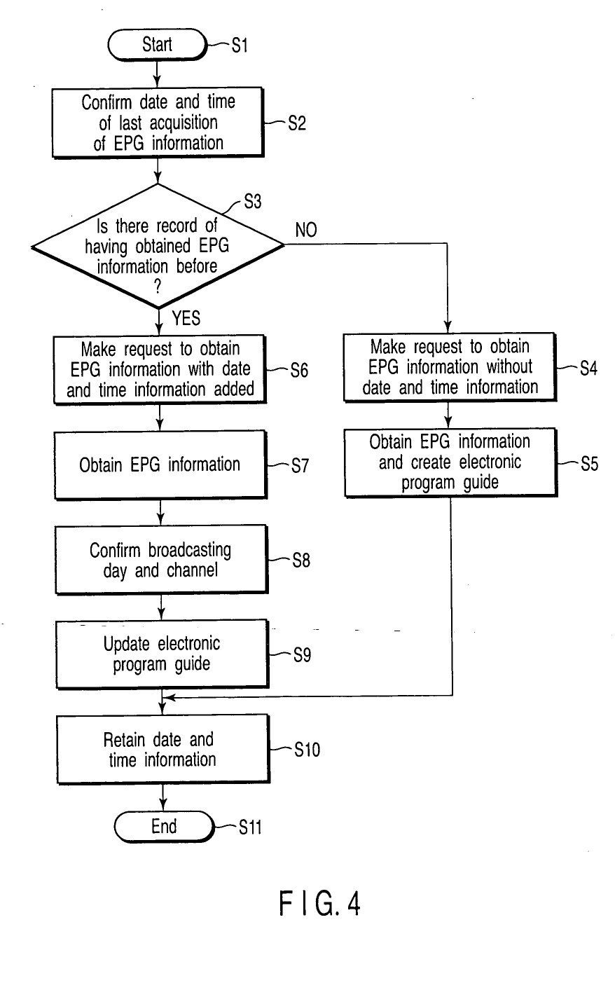

FIG. 4 is a flowchart illustrating the operation of the recording/reproducing apparatus 11 to obtain EPG information from the server 13. At the start of the EPG information obtaining operation (step S1), the microcomputer 21 refers to the nonvolatile RAM in the memory 21b in step S2 to confirm information about the date and time of the last acquisition of EPG information.

The microcomputer block 21 then makes a decision in step S3 of whether or not information about the date and time of the last acquisition of EPG information has been recorded in the nonvolatile RAM of the memory 21b, that is, whether or not there is a record of having obtained EPG information before.

If the decision is that the user has never obtained EPG information (NO in step S3), then the microcomputer block 21 makes a request to obtain EPG information to the server 13 in step S4 with no information about the date and time of the last acquisition of EPG information added.

Upon receipt of the request to obtain EPG information with no information about the date and time of the last acquisition of EPG information added, the server 13 fetches from the database 14 all the EPG information corresponding to all the broadcast channels that will be received in the area where the requesting recording/reproducing apparatus 11 is installed and sends them to the recording/reproducing apparatus 11.

Thus, the microcomputer block 21 obtains the EPG information sent from the server 13 and then creates an electronic program guide on the basis of the EPG information in step S5. After that, the microcomputer block 21 writes the EPG information thus obtained, the electronic program guide, and information about the date and time when the EPG information was obtained into the nonvolatile RAM in the memory 21b in step S10 and then completes the procedure (step S11).

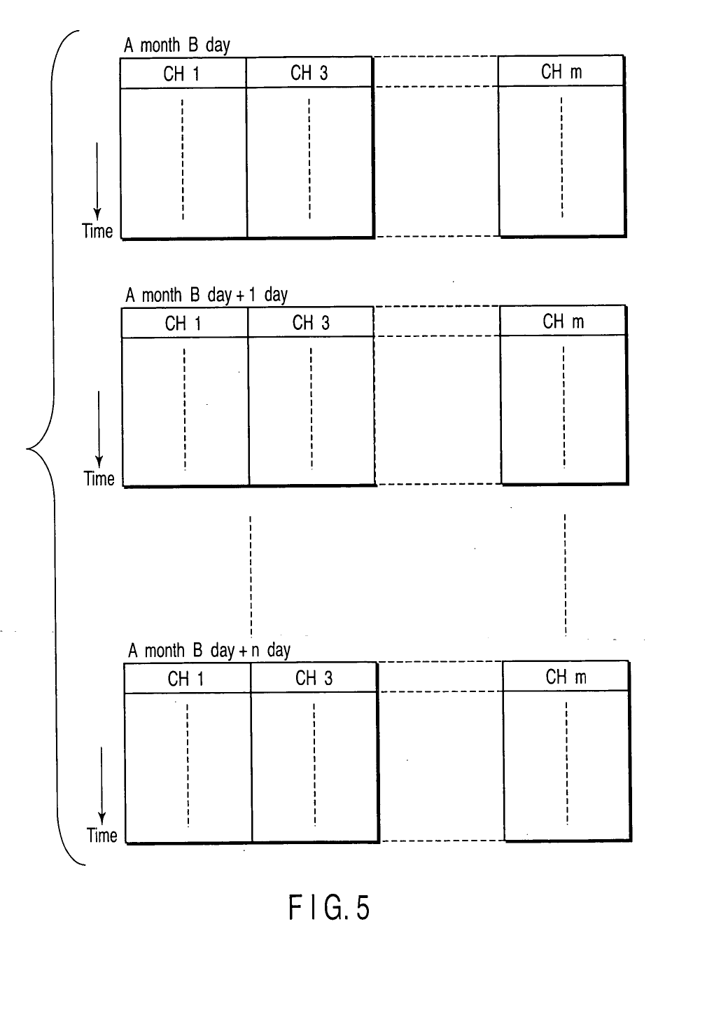

FIG. 5 shows an example of an electronic program guide created from the EPG information and recorded in the nonvolatile RAM of the memory 21b. In this example, the electronic program guide is in the form of a list in which programs scheduled to be broadcast on each of the channels CH1, CH3, . . . , CHm that can be received during (n+1) days from A month B day to A month (B+n) day are arranged in a sequential order of broadcasting start time.

Referring back to FIG. 4, if the decision in step S3 is that the user has ever received EPG information (YES), then the microcomputer block 21 makes a request to obtain EPG information to the server 13 with information about the date and time of the last acquisition of EPG information added in step S6.

Upon receipt of the request for EPG information with information about the date and time of the last acquisition of EPG information added, the server 13 makes a decision of whether or not, at present, there are additions or changes made to the EPG information that was sent to the requesting recording/reproducing apparatus 11 last time. If there are additions or changes, then the server 13 sends EPG information including the additions or changes to the recording/reproducing apparatus 11.

That is, if there are additions or changes to EPG information, the server 13 sends to the requesting recording/reproducing apparatus 11 one day of EPG information for the channel to the EPG information of which additions or changes have been made.

The microcomputer block 21 obtains the EPG information sent from the server 13 in step S7, then confirms the broadcasting day and channel of the EPG information thus obtained in step S8 and updates the electronic program guide in step S9.

After that, the microcomputer block 21 writes information about the date and time when the EPG information was obtained into the nonvolatile RAM of the memory 21 in step S10 and then completes the procedure (step S1).

More specifically, if, for example, additions or changes have been made to the EPG information for programs scheduled to be broadcast on A month (B+1) day and the channel CH3, then the server 13 sends to the recording/reproducing apparatus 11 all the EPG information for the channel CH3 of A month (B+1) day including the additions or changes.

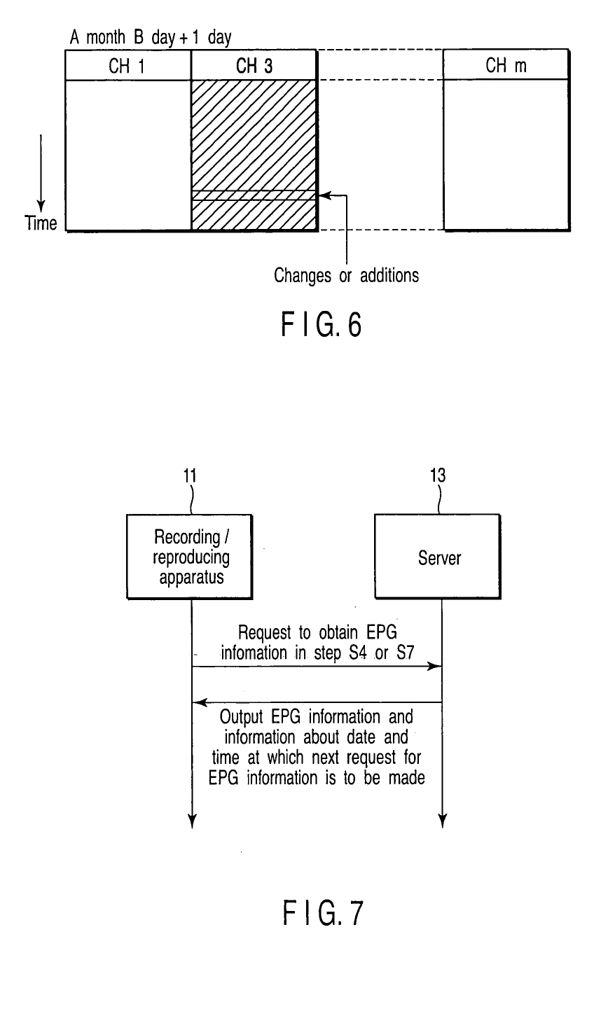

The microcomputer block 21 updates all the electronic program guide for the channel CH3 of A month (B+1) day on the basis of the EPG information including the additions or changes which has been sent from the server 13 as indicated by oblique lines in FIG. 6.

According to such a configuration as described above, in making a request to obtain EPG information to the server 13, the recording/reproducing apparatus 11 presents to the server information about the date and time of the last acquisition of EPG information and, in response to this, the server 13 simply outputs only EPG information for a channel or channels to the EPG information of which additions or changes has been made. It therefore becomes possible to alleviate the load on the server 13, increase the speed at which EPG information is obtained, and make efficient the operation of obtaining EPG information from the server 13.

Moreover, if additions or changes have been made to EPG information of a channel for one day, the sever 13 simply outputs all the EPG information of the channel including addition or changes for that day, thus eliminating the need of searching the database 14 for additions or changes. In this respect as well, the operation of obtaining EPG information can be made more efficient.

Furthermore, when a desired program is reserved using an electronic program guide created on the basis of EPG information obtained from the server 13, the program, upon being broadcast, can be automatically recorded on the optical disk 15 or the hard disk 17a.

FIG. 7 shows a modification of the EPG information obtaining operation of the recording/reproducing apparatus 11. That is, when the recording/reproducing apparatus 11 makes a request to obtain EPG information to the server 13 under the condition shown in step S4 or S6 in FIG. 4, the server 13 outputs to the recording/reproducing apparatus 11 not only EPG information but also information that specifies the date and time at which the next request for EPG information is to be made.

The recording/reproducing apparatus 11 creates or updates an electronic program guide on the basis of the EPG information obtained from the server 13 and writes the information that specifies the date and time at which the next request for EPG information is to be made into the nonvolatile RAM of the memory 21. Upon arrival of the date and time at which the next request for EPG information is to be made, the recording/reproducing apparatus 11 makes a request to obtain EPG information to the server 13 under the condition shown in step S4 or S6 in FIG. 4.

By causing the server 13 to, as requested by the recording/reproducing apparatus 11, output not only EPG information but also information that specifies the date and time at which the next request for EPG information is to be made to the requesting recording/reproducing apparatus, requests for EPG information from many users can be dispersed in time.

It therefore becomes possible to prevent a large number of requests for EPG information from being made during a certain period of time, allowing the load on the server 13 to be alleviated, the speed at which EPG information is obtained to be increased, and the operation of obtaining EPG information from the server 13 to be made more efficient.

The present invention is not limited to the embodiments described above. At the stage of practice of the invention, constituent elements can be variously modified without departing from the scope and spirit thereof. The constituent elements described in the above embodiments can be combined appropriately to form various inventions. For example, some components may be removed from all the constituent elements shown in the embodiments. In addition, the constituent elements in the different embodiments may be combined appropriately.

1. A broadcast receiver comprising:
a broadcast receiving unit configured to receive a broadcast signal;
a program guide information acquisition requesting unit configured to make a request to obtain program guide information for broadcast programs which can be received by the broadcast receiving unit to a server over a communication line and, if there is a record of having obtained program guide information from the server before, to present information about the date and time of the last acquisition of program guide information to the server;
a first program guide information acquisition unit configured to obtain program guide information from the server requested by the program guide information acquisition requesting unit in a state where there is no record of having obtained program guide information from the server before and create an electronic program guide on the basis of the program guide information; and
a second program guide information acquisition unit configured to obtain program guide information from the server requested by the program guide information acquisition requesting unit in a state where there is a record of having obtained program guide information from the server before, the program guide information containing changes or additions made to the last program guide information during a period between the date and time of the last acquisition of program guide information and the present time, retain information about the date and time of the acquisition of the program guide information containing changes or additions, and update the electronic program guide on the basis of the program guide information obtained.

2. A broadcast receiver according to claim 1, wherein the program guide information acquisition requesting unit obtains information which specifies the data and time when the next request to obtain program guide information is to be made from the server together with program guide information and makes a request to obtain program guide information to the server on the specified date and time.

3. A broadcast receiver according to claim 1 or 2, wherein the second program guide information acquisition unit obtains one day of program guide information containing changes or additions for a broadcast channel corresponding to the program guide information to which changes or additions have been made.

4. A broadcast receiving method comprising:
the step of receiving a broadcast signal;
the step of making a decision of, in making a request to obtain program guide information for broadcast programs which can be received to a server over a communication line, whether or not there is a record of having obtained program guide information from the server before;
the step of, if there is no record of having obtained program guide information before, making a request to obtain program guide information to the server with notification to the effect that there is no record of having obtained program guide information;
the step of obtaining program guide information for all the broadcast programs that can be received from the server requested in a state where there is no record of having obtained program guide information from the server before and then creating an electronic program guide on the basis of the program guide information;
the step of, if there is a record of having obtained program guide information before, making a request to obtain program guide information to the server with information indicating the date and time of the last acquisition of program guide information; and
the step of obtaining program guide information from the server requested in a state where there is a record of having obtained program guide information from the server before, the program guide information containing changes or additions made to the last program guide information during a period of time between the date and time of the last acquisition of program guide information and the present time, retaining information about the date and time of the acquisition of the program guide information containing changes or additions, and updating the electronic program guide on the basis of the program guide information obtained.

5. A broadcast receiving method according to claim 4, wherein the step of making a request to obtain program guide information to the server when there is no or a record of having obtained program guide information before comprises obtaining information which specifies the data and time when the next request to obtain program guide information is to be made from the server together with program guide information and making a request to obtain program guide information to the server on the specified date and time.

6. A broadcast receiving method according to claim 4 or 5, wherein the step of obtaining program guide information from the server requested in a state where there is a record of having obtained program guide information from the server before, the program guide information containing changes or additions made to the last program guide information during a period of time between the date and time of the last acquisition of program guide information and the present time comprises obtaining one day of program guide information containing changes or additions for a broadcast channel corresponding to the program guide information to which changes or additions have been made.

7. A program recording apparatus comprising:
a broadcast receiving unit configured to receive a broadcast signal;
a program guide information acquisition requesting unit configured to make a request to obtain program guide information for broadcast programs which can be received by the broadcast receiving unit to a server over a communication line and, if there is a record of having obtained program guide information from the server before, to present information about the date and time of the last acquisition of program guide information to the server;
a first program guide information acquisition unit configured to obtain program guide information from the server requested by the program guide information acquisition requesting unit in a state where there is no record of having obtained program guide information from the server before and create an electronic program guide on the basis of the program guide information;
a second program guide information acquisition unit configured to obtain program guide information from the server requested by the program guide information acquisition requesting unit in a state where there is a record of having obtained program guide information from the server before, the program guide information containing changes or additions made to the last program guide information during a period between the date and time of the last acquisition of program guide information and the present time, retain information about the date and time of the acquisition of the program guide information containing changes or additions, and update the electronic program guide on the basis of the program guide information obtained; and
a recording unit configured to, in a state where a program has been reserved on the basis of the program guide created or updated by the first or second program guide information acquisition unit, receive the reserved program by the broadcast receiving unit when it is broadcast and recording it on the recording medium.

8. A program recording apparatus according to claim 7, wherein the program guide information acquisition requesting unit obtains information which specifies the data and time when the next request to obtain program guide information is to be made from the server together with program guide information and makes a request to obtain program guide information to the server on the specified date and time.

9. A program recording apparatus according to claim 7 or 8, wherein the second program guide information acquisition unit obtains one day of program guide information containing changes or additions for a broadcast channel corresponding to the program guide information to which changes or additions have been made.

10. A program recording method comprising:
the step of receiving a broadcast signal;
the step of making a decision of, in making a request to obtain program guide information for broadcast programs which can be received to a server over a communication line, whether or not there is a record of having obtained program guide information from the server before;
the step of, if there is no record of having obtained program guide information before, making a request to obtain program guide information to the server with notification to the effect that there is no record of having obtained program guide information;
the step of obtaining program guide information for all the broadcast programs that can be received from the server requested in a state where there is no record of having obtained program guide information from the server before and then creating an electronic program guide on the basis of the program guide information;
the step of, if there is a record of having obtained program guide information before, making a request to obtain program guide information to the server with information indicating the date and time of the last acquisition of program guide information;
the step of obtaining program guide information from the server requested in a state where there is a record of having obtained program guide information from the server before, the program guide information containing changes or additions made to the last program guide information during a period of time between the date and time of the last acquisition of program guide information and the present time, retaining information about the date and time of the acquisition of the program guide information containing changes or additions, and updating the electronic program guide on the basis of the program guide information obtained;
the step of reserving a given program for recording on the basis of the program guide; and
the step of receiving the reserved program when it is broadcast and recording it on a recording medium.

11. A program recording method according to claim 10, wherein the step of making a request to obtain program guide information to the server when there is no or a record of having obtained program guide information before comprises obtaining information which specifies the data and time when the next request to obtain program guide information is to be made from the server together with program guide information and making a request to obtain program guide information to the server on the specified date and time.

12. A broadcast receiving method according to claim 10 or 11, wherein the step of obtaining program guide information from the server requested in a state where there is a record of having obtained program guide information from the server before, the program guide information containing changes or additions made to the last program guide information during a period of time between the date and time of the last acquisition of program guide information and the present time comprises obtaining one day of program guide information containing changes or additions for a broadcast channel corresponding to the program guide information to which changes or additions have been made.
